(19) United States
(12) Patent Application Publication
(10) Pub. No.: US 2024/0099179 A1
(43) Pub. Date: Mar. 28, 2024

(54) MACHINE LEARNING-BASED HYPERSPECTRAL DETECTION AND VISUALIZATION METHOD OF NITROGEN CONTENT IN SOIL PROFILE

(71) Applicant: INSTITUTE OF SOIL SCIENCE, CAS, Nanjing (CN)

(72) Inventors: Shengxiang XU, Nanjing (CN); Feng LIU, Nanjing (CN); Xianzhang PAN, Nanjing (CN); Changkun WANG, Nanjing (CN)

(73) Assignee: INSTITUTE OF SOIL SCIENCE, CAS, Nanjing (CN)

(21) Appl. No.: 18/369,746

(22) Filed: Sep. 18, 2023

(30) Foreign Application Priority Data
Sep. 20, 2022 (CN) 202211143677.1

(51) Int. Cl. A01B 79/02; A01B 79/00; G06V 20/10

(52) U.S. Cl. CPC A01B 79/02; A01B 79/005; G06V 20/194

(57) ABSTRACT

The present disclosure provides a machine learning-based hyperspectral detection and visualization method of a nitrogen content in a soil profile. The method includes the following steps: collecting a plurality of soil profile samples; obtaining hyperspectral image data of a soil profile; selecting a plurality of rectangular ranges on a hyperspectral image as region of interest (ROIs), calculating an average spectral curve of all pixels in the ROIs, and analyzing and measuring standard contents of nitrogen in the soil samples corresponding to the ROIs; constructing hyperspectral prediction models of five types of soil nitrogen in the soil profile with reference to different learning algorithms respectively with an average spectrum of ROIs after preprocessing as a predictive variable and a standard soil nitrogen content as a response variable; selecting an optimal prediction model based on evaluation indexes to predict and visualize contents of different forms of nitrogen in the entire soil profile.

### CROSS REFERENCE TO RELATED APPLICATION

This patent application claims the benefit and priority of Chinese Patent Application No. 202211143677.1, filed with the China National Intellectual Property Administration on Sep. 20, 2022, the disclosure of which is incorporated by reference herein in its entirety as part of the present application.

### TECHNICAL FIELD

The present disclosure relates to the technical field of soil property detection, and in particular, to a machine learning-based hyperspectral detection and visualization method of a nitrogen content in a soil profile.

### BACKGROUND

Currently, the total nitrogen content in soil is determined according to China's national standard GB 7173-87 (semi-micro-Kjeldahl method). That is, when a sample is digested with concentrated sulfuric acid in the presence of an accelerator, various nitrogen-containing organic compounds are converted into ammonium nitrogen by a complex high-temperature decomposition reaction. Ammonia distilled after alkalization is absorbed by boric acid and titrated with an acid standard solution to obtain the total nitrogen content in soil. Similarly, the determining of nitrogen such as alkali-hydrolyzable nitrogen, nitrate nitrogen, ammonium nitrogen and microbial biomass nitrogen also needs extraction by certain chemical reagents, and then adopts corresponding analysis methods. Although relatively reliable measurement results can be obtained based on these analysis methods, the implementation is time-consuming and laborious, not only consumes a lot of chemical reagents, but also causes severe environmental pollution. Moreover, special analytical instruments (such as an azotometer and a flow analyzer) are needed and are inconvenient to use. In addition, a final determining analysis result provides only an average value of the nitrogen content in the soil sample, and cannot provide spatial distribution information of the soil nitrogen in the profile.

Visible-near infrared spectroscopy, as a rapid and nondestructive detection means, has been widely used in detection of food components and soil properties. However, the visible-near infrared spectroscopy can only calculate physical and chemical values of a detected object based on spectral information of the sample, but cannot obtain external information of the sample, let alone visualize spatial distribution information of the component or property content. Hyperspectral imaging technology is an image data acquisition technology developed on the basis of visible-near infrared spectroscopy and multispectral imaging technologies in recent a dozen years. In the spectral range from visible to near infrared (400-2500 nm), an imaging spectrometer is used to continuously image a target object, which has spectral information of different wavelengths of pixels in an image, and has image information at a specified wavelength. Currently, the technology has been widely used in terms of nondestructive testing of agricultural products, crop identification, disease diagnosis, soil property prediction, and the like.

### SUMMARY

To solve the technical problems existing in the background, the present disclosure provides a machine learning-based hyperspectral detection and visualization method of a nitrogen content in a soil profile.

The following technical solutions are used in the present disclosure: A machine learning-based hyperspectral detection and visualization method of a nitrogen content in a soil profile includes at least the following steps:

sampling soil in a detection area based on a predetermined depth to obtain a plurality of soil profile samples about the detection area; obtaining an initial hyperspectral image of each soil profile sample, and performing image preprocessing on the initial hyperspectral image to obtain an effective hyperspectral image;

selecting n regions of interest that are continuously distributed and have the same shape and size on the effective hyperspectral image, and calculating n pieces of average spectral data based on all pixels of each region of interest, where n is an integer; detecting contents of at least five forms of nitrogen in the soil profile samples in each region of interest to obtain a standard content of each form of soil nitrogen; and

establishing a plurality of hyperspectral prediction models by using at least one learning algorithm; selecting an optimal prediction model corresponding to a soil nitrogen form from the plurality of hyperspectral prediction models based on evaluation indexes, predicting a soil nitrogen content corresponding to each pixel of the hyperspectral image of the soil profile in the corresponding form based on the optimal prediction model, denoting the soil nitrogen content as a predicted soil nitrogen content, and outputting the predicted soil nitrogen content to obtain a visualized image.

In a further embodiment, a process of establishing the hyperspectral prediction model includes the following steps:

detecting outliers of all the average spectral data by using a principal component analysis method to determine whether there is an abnormal average spectral curve, and if yes, eliminating the abnormal average spectral curve; and randomly dividing filtered average spectral data into a modeling set and a validation set at 7:3;

assigning a value range and a search step size to parameters of each learning algorithm to obtain a corresponding parameter combination; for each form of soil nitrogen, performing parameter optimization on each parameter combination by grid search and 10-fold cross-validation to obtain a corresponding optimal parameter combination; and

establishing a regression relationship between hyperspectral signals and different soil nitrogen contents based on the optimal parameter combination with preprocessed average spectral data as a predictive variable and the standard content of soil nitrogen as a response variable.

In a further embodiment, the learning algorithm includes at least a partial least square regression (PLSR) algorithm, an artificial neuron network (ANN) algorithm, and a support vector machine regression (SVMR) algorithm; and

correspondingly, the plurality of hyperspectral prediction models are a PLSR prediction model, an ANN prediction model, and an SVMR prediction model.

In a further embodiment, the evaluation index includes at least a determination coefficient, a root mean square error, and a quartile relative prediction error; and a process of selecting the optimal prediction model includes the following step:

evaluating evaluation values of five forms of soil nitrogen predicted by different hyperspectral prediction models in the modeling set and the validation set, and selecting according to the following criteria:

$$\{ \begin{matrix}{R}^{2} \geq 0.9 and RPIQ \geq 4.05 & Excellent fitting performance \\ 0.82 \leq {R}^{2} < 0.9 and 3.37 \leq RPIQ < 4.05 & Good fitting performance \\ 0.66 \leq {R}^{2} < 0.82 and 2.7 \leq RPIQ < 3.37 & Fitting approximately quantitatively \\ 0.5 \leq {R}^{2} < 0.66 and 2.02 \leq RPIQ < 2.7 & Only a high value and a low \\ & value is distinguished \\ {R}^{2} < 0.5 and RPIQ < 2.02 & It is difficult to be used for \\ & quantitative analysis\end{matrix}$$

where R² represents an evaluation value of the determination coefficient, and RPIQ represents an evaluation value of the quartile relative prediction error.

In a further embodiment, a process of outputting the visualized image includes the following steps:

obtaining a soil hyperspectral image based on a soil profile sample, obtaining each pixel on the soil hyperspectral image and a corresponding spectral reflectance curve, inputting the spectral reflectance curve into the optimal prediction model, and obtaining a predicted gray-scale image by means of the optimal prediction model, where the predicted gray-scale image includes at least a plurality of predicted pixels and spatial positions corresponding to the predicted pixels; and

performing pseudo-color processing on the predicted gray-scale image to obtain a visualized image about contents of total nitrogen, alkali-hydrolyzable nitrogen, ammonium nitrogen, nitrate nitrogen and microbial biomass nitrogen in the soil profile sample, where the visualized image is a color distribution map.

In a further embodiment, the five forms of nitrogen is soil total nitrogen, alkali-hydrolyzable nitrogen, ammonium nitrogen, nitrate nitrogen, and microbial biomass nitrogen.

In a further embodiment, an optimal parameter combination of the PLSR prediction model is a corresponding parameter combination when a root mean square error value of 10-fold cross-validation is minimum or has no significant change; and

optimal parameter combinations of the ANN prediction model and the SVMR prediction model each are a parameter combination corresponding to a minimum root mean square error value of 10-fold cross-validation.

In a further embodiment, the image preprocessing of the initial hyperspectral image includes at least the following process:

performing gray-scale and geometric correction on the initial hyperspectral image, and sequentially denoising and stretching.

In a further embodiment, a method for preprocessing the average spectral data includes one or more of an apparent absorption rate, a first derivative, a second derivative, Savitzky-Golay smoothing, a Gap-Segment derivative, detrending, or standard normal variable transformation.

The present disclosure has the beneficial effects that according to the present disclosure, contents of total nitrogen, alkali-hydrolyzable nitrogen, ammonium nitrogen, nitrate nitrogen and microbial biomass nitrogen in an undisturbed soil profile can be rapidly and accurately predicted, and their spatial distribution on the soil profile can be visually drawn, thereby making up for the shortcomings of a conventional laboratory chemical analysis method and conventional visible-near infrared spectroscopy.

The sampling range of the present disclosure covers typical black soil, fluvo-aquic soil, paddy soil and farmland soil profiles in other distribution areas, so as to implement rapid monitoring and visualized mapping of contents of different forms of nitrogen in an undisturbed soil profile in a typical soil area.

Through model evaluation and optimization, a self-learning model having strong robustness and high prediction accuracy can be selected and extended to prediction and visualized mapping of contents of different forms of nitrogen in undisturbed soil profiles of farmland with similar soil types in China, to study the input, output and internal circulation process of different nitrogen in soil profiles and guide soil quality evaluation, and the like.

### BRIEF DESCRIPTION OF THE DRAWINGS

FIG. 1 is a flowchart of a hyperspectral detection and visualization method of a nitrogen content in a soil profile according to Embodiment 1;

FIGS. 2A-B are contrast diagrams of a pixel of a hyperspectral image of a soil profile before and after calibration by using a black-and-white board in Embodiment 1;

FIG. 3 is an average spectral curve graph of region of interest (ROI) samples of one of soil profiles in Embodiment 1;

FIG. 4 is a schematic diagram showing the identification of outliers of soil ROI samples in Embodiment 1;

FIG. 5 is a comparison diagram of prediction performance of three prediction models about five forms of soil nitrogen in Embodiment 1; and

FIG. 6 is a visualized distribution diagram of contents of five forms of nitrogen in a black soil profile in an embodiment.

### DETAILED DESCRIPTION OF THE EMBODIMENTS

Nitrogen is one of macronutrient elements needed for plant growth and development, and is also a mineral element that plants absorb the most from soil. The nitrogen plays an important role in soil fertility, nitrogen cycle and environmental protection, and has long been greatly noted by researchers. Nitrogen in soil is mostly combined with inorganic minerals, resulting in a wide variety and a relatively complicated existing state of the nitrogen. Because of large inventory of soil total nitrogen and its response to farming management measures is slow, the determining of the soil total nitrogen alone cannot accurately reflect dynamic changes of soil nitrogen. Nitrate nitrogen and ammonium nitrogen are mineral nitrogen that can be directly absorbed and utilized by plants. Although their contents are low, they are the most easily depleted nitrogen forms that restrict crop growth in a farmland ecosystem. In addition, the nitrate nitrogen is extremely prone to downward leaching, which makes the nitrate nitrogen show unique spatial distribution characteristics. The content of soil alkali-hydrolyzable nitrogen represents the intensity of soil nitrogen supply and reflects available nitrogen for crops in season. Microbial biomass nitrogen in soil is an important component of a soil active nitrogen pool, which can respond quickly to changes in farmland management measures within a crop growing season. The farmland management measures not only affect changes of the nitrogen content in an arable layer of soil, but also affect the profile distribution of soil nitrogen due to the downward movement of nitrogen and the function of crop roots. Therefore, studying the vertical distribution of soil total nitrogen, alkali-hydrolyzable nitrogen, nitrate nitrogen, ammonium nitrogen and microbial biomass nitrogen can better explore the input, output and internal circulation process of soil nitrogen, and provide a theoretical basis for formulating measures such as rational application of a nitrogen fertilizer.

The disclosure with the application (patent) number of CN201710326245.7 discloses a pretreatment method for soil nitrogen detection based on a portable near infrared spectrometer, including the following steps. Step 1: Pretreat a soil sample, where the pretreatment method includes the following steps: drying the soil sample at 60-70° C. for at least 12 hours, cooling the soil sample to room temperature, grinding the soil sample to a particle size less than or equal to 160 m, and pressing the soil sample into a cuboid sample. Step 2: Detect the cuboid sample by using a near infrared spectrum to obtain spectral information. Step 3: Input the spectral information into a relationship model between spectral signals and the soil nitrogen content to obtain the soil nitrogen content. Similarly, the disclosure with the application (patent) number of CN202010583170.2 discloses a method for analyzing a relationship between a plant growth state and a soil nitrogen content based on hyper-spectrum, including the following steps. Step A: Set up a plurality of experimental groups of the same plant, apply the same nitrogen fertilizer with different components to the experimental groups respectively for planting, and record a plant growth state of each experimental group. Step B: Collect imaging spectral data of the soil of each experimental group by an SOC710VP hyperspectral to obtain a digital number (DN) value, and then convert the DN value into reflectance. Step C: Preprocess the reflectance, and determine the nitrogen content in the soil by means of the reflectance to obtain the nitrogen content in the soil of each experimental group. Step D: Determine a relationship between the nitrogen content in the soil and the plant growth state based on different amounts of nitrogen fertilizer applied in the experimental groups.

Although the methods according to the above-mentioned disclosures can obtain the nitrogen content in the soil with high detection accuracy, they cannot obtain the spatial distribution information of the nitrogen content in the entire undisturbed soil profile. In addition, the disclosures cannot detect contents of other nitrogen (such as alkali-hydrolyzable nitrogen, nitrate nitrogen, ammonium nitrogen, and microbial biomass nitrogen).

### Embodiment 1

This embodiment provides a method that can quickly detect and visualize contents of total nitrogen, alkali-hydrolyzable nitrogen, nitrate nitrogen, ammonium nitrogen and microbial biomass nitrogen in an undisturbed soil profile of farmland.

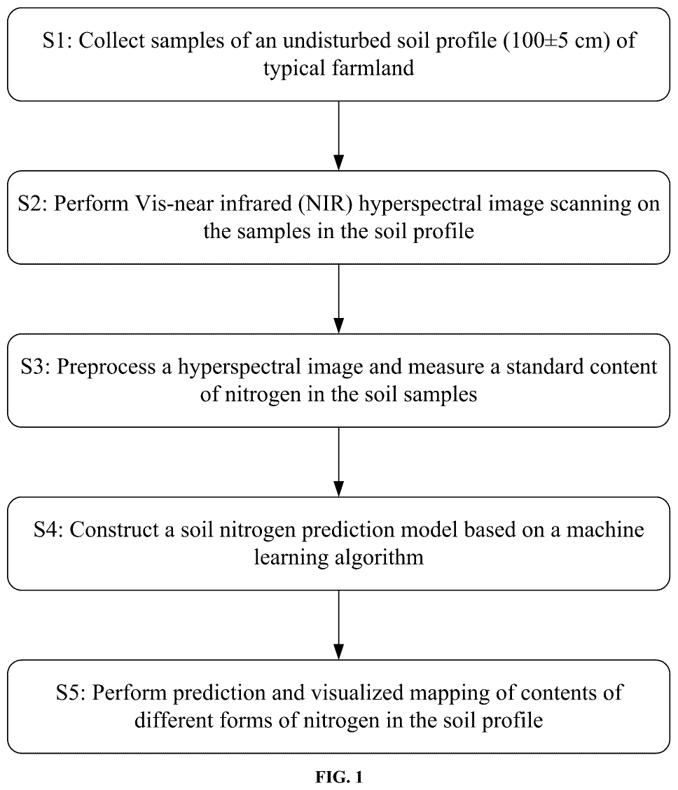

As shown in FIG. 1, the machine learning-based hyperspectral detection and visualization method of a nitrogen content in a soil profile includes at least the following steps.

Step 1: Sample soil in a detection area based on a predetermined depth to obtain a plurality of soil profile samples about the detection area; obtain an initial hyperspectral image of each soil profile sample, and perform image preprocessing on the initial hyperspectral image to obtain an effective hyperspectral image. In this embodiment, there were three types of soil in the detection area, namely, black soil, fluvo-aquic soil, and paddy soil. According to a depth of 100±5 cm in distribution areas of the above three soil types, samples in an undisturbed soil profile were taken by a soil sampling drill, and there were 3, 4, and 4 samples in the undisturbed soil profile respectively.

Step 2: Select n regions of interest that are continuously distributed and have the same shape and size on the effective hyperspectral image, and calculate n pieces of average spectral data based on all pixels of each region of interest, where n is an integer; and detect contents of at least five forms of nitrogen in the soil profile samples in each region of interest to obtain a standard content of each form of soil nitrogen.

Step 3: Establish a plurality of hyperspectral prediction models by using at least one learning algorithm; select an optimal prediction model corresponding to a soil nitrogen form from the plurality of hyperspectral prediction models based on evaluation indexes, predict a soil nitrogen content corresponding to each pixel of the hyperspectral image of the soil profile in the corresponding form based on the optimal prediction model, denote the soil nitrogen content as a predicted soil nitrogen content, and output the predicted soil nitrogen content to obtain a visualized image.

In a further embodiment, in step 1, 11 samples in the undisturbed soil profile with a length of 100±5 cm and a diameter of about 8.4 cm were collected by using an Eijkelkamp soil sampling drill in the Netherlands in 1-2 weeks after crop harvest. Encoding was performed according to a sampling sequence and sample collection information, including latitude and longitude, an elevation, a sampling depth, a crop type, and the like, was recorded in detail. The undisturbed soil samples were placed in polyvinyl chloride (PVC) tubes, with two ends sealed to prevent water volatilization and prevent large vibration during transportation to prevent a soil profile from breaking.

A process of preparing soil profile samples was as follows: each collected soil profile sample was vertically cut by using a stainless steel knife into two semi-cylindrical profile samples in an axial direction for hyperspectral scanning. Since the soil moisture content, soil particles, surface roughness, and the like have a great influence on the visible-near infrared spectrum, the cut semi-cylindrical soil profile sample was properly air-dried, and obvious gravels, plant residues, and the like were manually removed.

The initial hyperspectral image in step 1 was obtained in the 400-1010 nm band range of the soil profile through scanning by a hyperspectral imaging system. Before scanning of the image data, firstly, parameters of a hyperspectral imaging platform were set: A vertical distance between a surface of the soil profile sample and a lens of a hyperspectral camera was 50 cm; a sample moving platform was at a speed of 1.0 mm/s; an exposure time of the hyperspectral camera was 13 ms; and the scanning wavelength range was 396-1019 nm (that is, 1040 bands). After the parameters of the hyperspectral imaging system were set, clear hyperspectral images of the undisturbed soil profile were continuously collected by linear scanning, some wavelengths at the beginning and end of a spectral region were removed, and finally the band in the range of 400-1010 nm (that is, 1020 bands) was reserved for hyperspectral modeling.

The images were saved as three-dimensional (3D) cube data with a suffix in dat format. An x-axis and a y-axis represent spatial distribution information of a two-dimensional image, and a z-axis represents hyperspectral wavelength information.

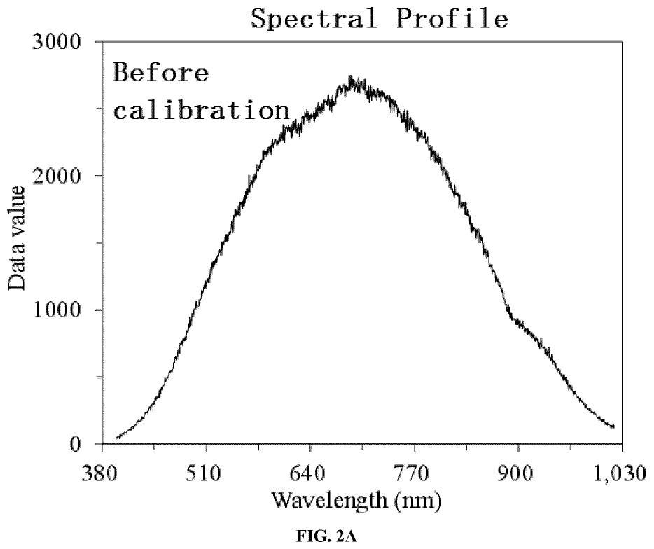

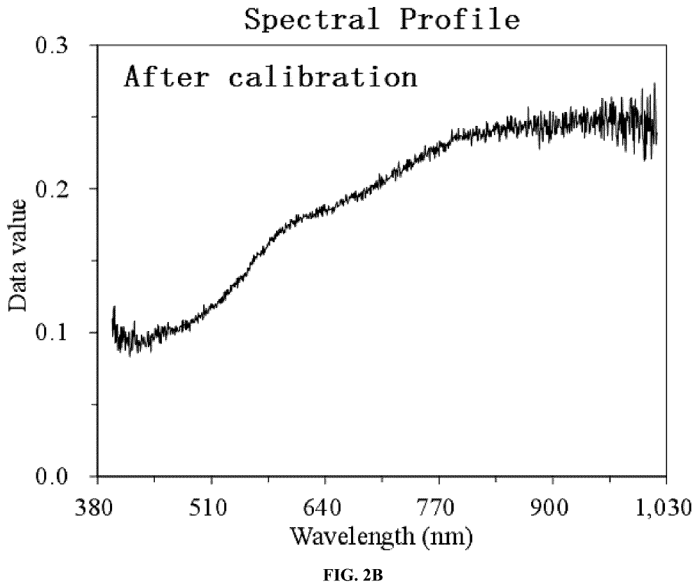

Image preprocessing was performed on the initial hyperspectral image to obtain an effective hyperspectral image. A specific image preprocessing process includes: performing gray-scale and geometric correction on the initial hyperspectral image, and sequentially denoising and stretching. In other words, the image preprocessing specifically includes the following steps. Step (1): After the image data scanning is completed, correct the DN value of the generated hyperspectral image of the soil profile through calibration by using a black-and-white board: under the same environmental conditions as when the soil sample image is scanned, first scan a polytetrafluoroethylene diffuse reflection whiteboard having a reflectance of 99% to obtain a full-white calibrated image (W_{White}), then cover the image with a camera objective cap to obtain a full-black calibrated image (D_{Black}), as shown in FIGS. 2A-B, and calculate a reflectance (R) of the calibrated hyperspectral image according to the following formula:

R=(DN−D_{Black})/(W_{White}−D_{Black})

Step (2): Geometrically correct the hyperspectral image in ENVI software, remove background noise in the hyperspectral image by masking, cutting and other steps, and stretch the image appropriately to obtain the corrected effective hyperspectral image of the soil profile sample.

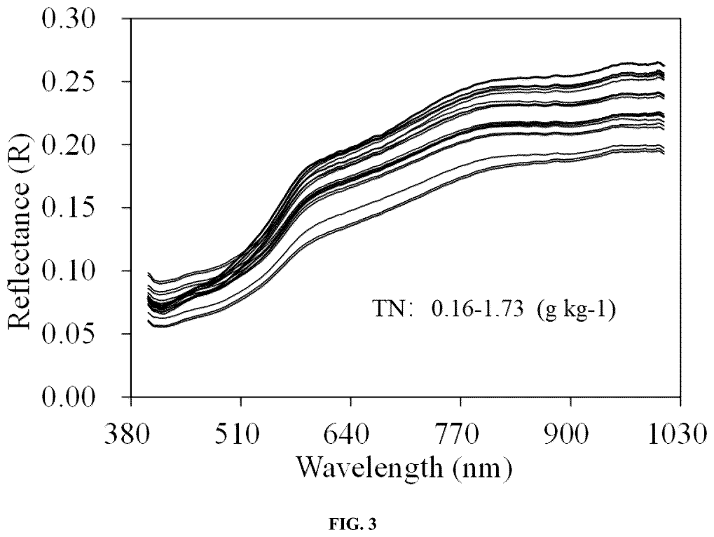

In a further embodiment, a method of selecting n ROIs in step 2 was as follows: Based on the above-mentioned embodiment, on each preprocessed effective hyperspectral image, 20±1 ROI samples (350×800 pixels) were continuously selected by an ROI rectangle tool of ENVI 5.3 software at equal intervals of 8.4 cm×5 cm, and an average spectral curve of all pixels in each ROI sample area was calculated, as shown in FIG. 3. A total of 220 pieces of ROI sample spectral data (average spectral curve graph) were obtained.

In order to reduce the influence of instrument background or drift, and the like on an original spectral reflectance, the following spectral preprocessing methods, such as an apparent absorption rate (log(1/R)), a first derivative, a second derivative, Savitzky-Golay smoothing, a Gap-Segment derivative, detrending, and standard normal variable transformation, were adopted. After comparison, a method for optimal spectral preprocessing of different forms of soil nitrogen was Savitzky-Golay smoothing (a first derivative, a second-order polynomial, and three smoothing points) was determined.

In a further embodiment, the five forms of nitrogen in step 2 was soil total nitrogen, alkali-hydrolyzable nitrogen, ammonium nitrogen, nitrate nitrogen, and microbial biomass nitrogen. In other words, the standard content of each form of soil nitrogen was as follows: Standard contents of soil total nitrogen (TN), alkali-hydrolyzable nitrogen (AN), ammonium nitrogen (NO₃—N), nitrate nitrogen (NH₄—N) and microbial biomass nitrogen (MBN) were measured in a laboratory for soil profile samples in each region of interest.

The method specifically included the following processes: Before laboratory analysis, soil samples were naturally air-dried indoors, visible gravels and plant residues were removed, and then the samples were ground and all passed through a 100-mesh sieve. The total nitrogen content in soil was determined by using China's national standard GB 7173-87 (semi-micro-Kjeldahl method), and the content of alkali-hydrolyzable nitrogen was determined by using an alkali-hydrolyzable diffusion method. The content of nitrate nitrogen and the content of ammonium nitrogen in soil were determined by a KCl-extracted continuous flow analyzer. The content of MBN was determined by a chloroform fumigation and K₂SO₄ extraction method, and an extraction correction factor was 0.54. The unit of the TN content in soil was g kg⁻¹, and units of AN, NO₃—N, NH₄·N and MBN were mg kg⁻¹. The standard content of each form of nitrogen was counted, as shown in Table 1.

TABLE 1
Statistical characteristics of standard contents of
different forms of nitrogen in soil profile samples

| | | | | | | Variation |
|---|---|---|---|---|---|---|
| Soil | Mini- | Maxi- | Average | | Standard | coefficient |
| properties | mum | mum | value | Median | deviation | (%) |
| TN | 0.14 | 3.18 | 0.93 | 0.69 | 0.72 | 77.42 |
| AN | 11.03 | 209.48 | 67.74 | 49.61 | 53.20 | 78.54 |
| NH₄•N | 1.16 | 16.05 | 4.56 | 3.42 | 2.71 | 59.43 |
| NO₃•N | 0.41 | 95.17 | 12.84 | 5.54 | 16.42 | 127.88 |
| MBN | 0.22 | 49.62 | 7.16 | 3.34 | 10.51 | 146.79 |

In a further embodiment, the at least one learning algorithm in step 3 is a PLSR algorithm, an ANN algorithm, and an SVMR algorithm. Correspondingly, the plurality of hyperspectral prediction models are a PLSR prediction model, an ANN prediction model, and an SVMR prediction model.

A process of establishing the hyperspectral prediction model includes the following steps.

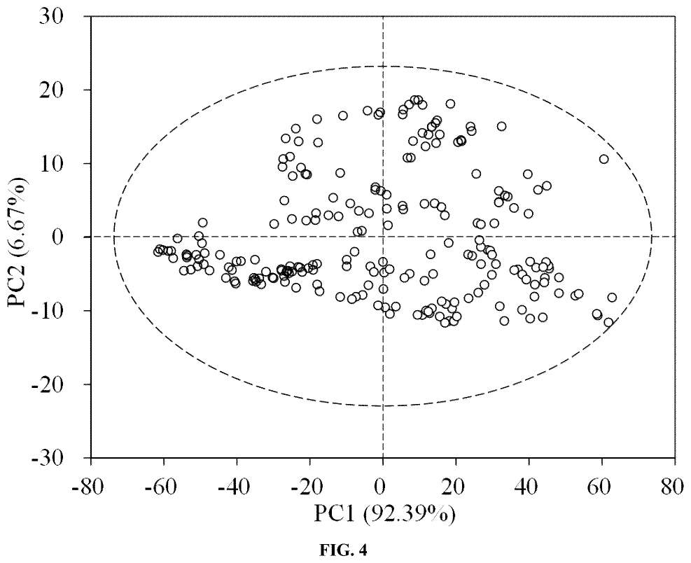

Step 301: Detect outliers of all the average spectral data by using a principal component analysis method to determine whether there is an abnormal average spectral curve, and if yes, eliminate the abnormal average spectral curve; and randomly divide filtered average spectral data into a modeling set and a validation set at 7:3. Based on the above embodiment, all ROI samples were classified into 155 modeling set samples and 65 validation set samples by using a random method, and the classification process was repeated for 100 times to evaluate robustness and uncertainty of the prediction model. In another embodiment, an outlier was detected by using the following method: Based on a principal component analysis (PCA) method, two feature vectors PC1 and PC2 with a maximum absolute value of a feature value were selected to draw a Hotelling T² ellipse (95% confidence level), and if all ROI sample points were located in the Hotelling T² ellipse, there was no spectral outlier, as shown in FIG. 4; or if there were sample points outside the ellipse, the outliers were eliminated.

Step 302: Assign a value range and a search step size to parameters of each learning algorithm to obtain a corresponding parameter combination; and for each form of soil nitrogen, perform parameter optimization on each parameter combination by grid search and 10-fold cross-validation to obtain a corresponding optimal parameter combination. In a further embodiment, the PLSR prediction model, the ANN prediction model and the SVMR prediction model are constructed by using R language packages such as pls, RSNNS and kernlab respectively. Model parameters are parameters used to control algorithm behavior when a model is established, and these parameters cannot be obtained from a conventional training process. Therefore, before models are trained, the models need to be assigned values. For each form of soil nitrogen, optimal parameters of the PLSR prediction model, the ANN prediction model and the SVMR prediction model are determined by grid search and 10-fold cross-validation. The PLSR model takes a corresponding number of principal components when a root mean square error (RMSE) value of 10-fold cross-validation is minimum or no longer significantly changes as an optimal number of principal components of PLSR, and the ANN and SVMR take a parameter combination corresponding to the minimum RMSE value of 10-fold cross-validation as an optimal parameter combination. A radial basis function (RBF) is adopted as a kernel function of the SVMR model.

For example, firstly, a value range and a search step size were set for parameters of each prediction algorithm: PLSR (number of potential variables of ncomp, variable factor=1, 2, 3, . . . , 20), ANN (layer1=1, 2, 3, . . . , 20; layer2=1, 2, 3, . . . , 20; layer3=1, 2, 3, . . . , 20), SVMR (sigma=(1, 2, 3, . . . , 10000)×10⁻⁴; C penalty coefficient=1, 2, 3, . . . , 200); secondly, a corresponding RMSE value of 10-fold cross-validation was calculated for each parameter combination, and all parameter combinations (“grid points”) were traversed by using an exhaustive method to find a parameter combination corresponding to the minimum RMSE as an optimal parameter of the prediction model, as shown in Table 2. The 10-fold cross-validation was to randomly divide sample data into 10 samples, take 9 samples as the training set in turn, and the remaining 1 sample as the test set for evaluation test. This process was repeated many times, and an average value was obtained, from which the optimal parameter with the minimum RMSE value was selected as the estimation of the accuracy of the algorithm.

TABLE 2
Optimal parameter values of different prediction models

| Model | Parameter | Search range | TN | AN | NH4—N | NO3—N | MBN |
|---|---|---|---|---|---|---|---|
| PLSR | ncomp | 1, 2, 3, . . . , 20 | 9 | 9 | 5 | 8 | 4 |
| ANN | layer1 | 1, 2, 3, . . . , 20 | 20 | 19 | 5 | 19 | 20 |
| | layer2 | 1, 2, 3, . . . , 20 | 13 | 3 | 2 | 13 | 16 |
| | layer3 | 1, 2, 3, . . . , 20 | 14 | 13 | 2 | 15 | 4 |
| SVMR | sigma | (1, 2, 3, . . . , 10000) × 10⁻⁴ | 1 × 10⁻³ | 5 × 10⁻⁴ | 2 × 10⁻⁴ | 4 × 10⁻³ | 8 × 10⁻³ |
| | C | 1, 2, 3, . . . , 200 | 3 | 11 | 29 | 17 | 10 |

Step 303: Establish a regression relationship between hyperspectral signals and different soil nitrogen contents based on the optimal parameter combination with preprocessed average spectral data as a predictive variable and the standard content of soil nitrogen as a response variable.

In a further embodiment, the evaluation index in step 3 includes at least a determination coefficient (R²), an RMSE, and a quartile relative prediction error (RPIQ); and a process of selecting the optimal prediction model includes the following: determination coefficient, root mean square error (RMSE) and quartile relative prediction error (RPIQ). The evaluation index is used to evaluate prediction performance of different prediction models in the modeling set and the validation set respectively, and select an optimal prediction model, specifically including the following steps: evaluating evaluation values of five forms of soil nitrogen predicted by different hyperspectral prediction models in the modeling set and the validation set, and selecting according to the following criteria:

$$\{ \begin{matrix}{R}^{2} \geq 0.9 and RPIQ \geq 4.05 & Excellent fitting performance \\ 0.82 \leq {R}^{2} < 0.9 and 3.37 \leq RPIQ < 4.05 & Good fitting performance \\ 0.66 \leq {R}^{2} < 0.82 and 2.7 \leq RPIQ < 3.37 & Fitting approximately quantitatively \\ 0.5 \leq {R}^{2} < 0.66 and 2.02 \leq RPIQ < 2.7 & Only a high value and a low \\ & value is distinguished \\ {R}^{2} < 0.5 and RPIQ < 2.02 & It is difficult to be used for \\ & quantitative analysis\end{matrix}$$

where R² represents an evaluation value of the determination coefficient, and RPIQ represents an evaluation value of the quartile relative prediction error.

Based on the above process, the modeling set and the validation set were evaluated. Evaluation results are shown in Table 3 and Table 4.

TABLE 3
Accuracy evaluation results of prediction models of different
forms of nitrogen in the soil profile based on the modeling set

| Soil | Evaluation | | | |
|---|---|---|---|---|
| properties | index | PLSR | ANN | SVMR |
| TN | RMSE | 0.28 ± 0.01 | 0.33 ± 0.01 | 0.17 ± 0.01 |
| | R² | 0.85 ± 0.01 | 0.93 ± 0.01 | 0.94 ± 0.01 |
| | RPIQ | 2.73 ± 0.09 | 3.97 ± 0.24 | 4.23 ± 0.21 |
| AN | RMSE | 18.79 ± 0.88 | 25.83 ± 1.16 | 13.62 ± 0.98 |
| | R² | 0.87 ± 0.01 | 0.92 ± 0.01 | 0.93 ± 0.01 |
| | RPIQ | 4.08 ± 0.21 | 5.22 ± 0.44 | 5.65 ± 0.45 |
| NH₄—N | RMSE | 1.72 ± 0.10 | 2.76 ± 0.09 | 1.54 ± 0.09 |
| | R² | 0.60 ± 0.03 | 0.65 ± 0.03 | 0.68 ± 0.03 |
| | RPIQ | 2.08 ± 0.12 | 2.23 ± 0.13 | 2.32 ± 0.14 |
| NO₃—N | RMSE | 10.79 ± 0.84 | 8.07 ± 0.51 | 7.18 ± 0.64 |
| | R² | 0.57 ± 0.03 | 0.78 ± 0.02 | 0.81 ± 0.03 |
| | RPIQ | 1.40 ± 0.12 | 1.97 ± 0.14 | 2.11 ± 0.19 |
| MBN | RMSE | 8.48 ± 0.43 | 7.27 ± 0.50 | 6.68 ± 0.64 |
| | R² | 0.34 ± 0.03 | 0.54 ± 0.07 | 0.58 ± 0.08 |
| | RPIQ | 0.54 ± 0.03 | 0.65 ± 0.05 | 0.69 ± 0.07 |

TABLE 4
Accuracy evaluation results of prediction models of different forms
of nitrogen in the soil profile based on the validation set

| Soil | Evaluation | | | |
|---|---|---|---|---|
| properties | index | PLSR | ANN | SVMR |
| TN | RMSE | 0.28 ± 0.03 | 0.35 ± 0.03 | 0.17 ± 0.02 |
| | R² | 0.86 ± 0.03 | 0.92 ± 0.02 | 0.94 ± 0.01 |
| | RPIQ | 2.63 ± 0.25 | 3.49 ± 0.45 | 4.11 ± 0.43 |
| AN | RMSE | 18.53 ± 2.05 | 27.16 ± 2.68 | 13.35 ± 2.12 |
| | R² | 0.88 ± 0.03 | 0.91 ± 0.03 | 0.94 ± 0.02 |
| | RPIQ | 4.03 ± 0.46 | 4.70 ± 0.70 | 5.67 ± 0.95 |
| NH₄—N | RMSE | 1.67 ± 0.20 | 2.86 ± 0.26 | 1.51 ± 0.23 |
| | R² | 0.63 ± 0.05 | 0.64 ± 0.07 | 0.70 ± 0.06 |
| | RPIQ | 2.07 ± 0.26 | 2.04 ± 0.31 | 2.31 ± 0.36 |
| NO₃—N | RMSE | 10.85 ± 1.60 | 9.01 ± 1.83 | 7.31 ± 1.25 |
| | R² | 0.59 ± 0.06 | 0.78 ± 0.06 | 0.82 ± 0.05 |
| | RPIQ | 1.41 ± 0.22 | 1.82 ± 0.35 | 2.11 ± 0.39 |
| MBN | RMSE | 8.57 ± 1.08 | 8.22 ± 1.42 | 6.85 ± 1.34 |
| | R² | 0.37 ± 0.07 | 0.51 ± 0.13 | 0.60 ± 0.13 |
| | RPIQ | 0.53 ± 0.07 | 0.57 ± 0.11 | 0.68 ± 0.14 |

Performance evaluation results of the modeling set and the validation set showed that in the three models, the prediction model of the five types of soil nitrogen based on the SVMR prediction model had the highest accuracy among the three models, and was determined as an optimal model for predicting and visualizing the nitrogen content in soil. R² of TN and AN contents in the soil profile was greater than or equal to 0.90 and RPIQ was greater than or equal to 4.05, indicating that the established SVMR model had excellent fitting performance. The prediction model of the NO₃·N content in the soil profile fitted approximately quantitatively. The prediction model of NH₄·N and MBN contents in the soil profile could only distinguish between a high value and a low value.

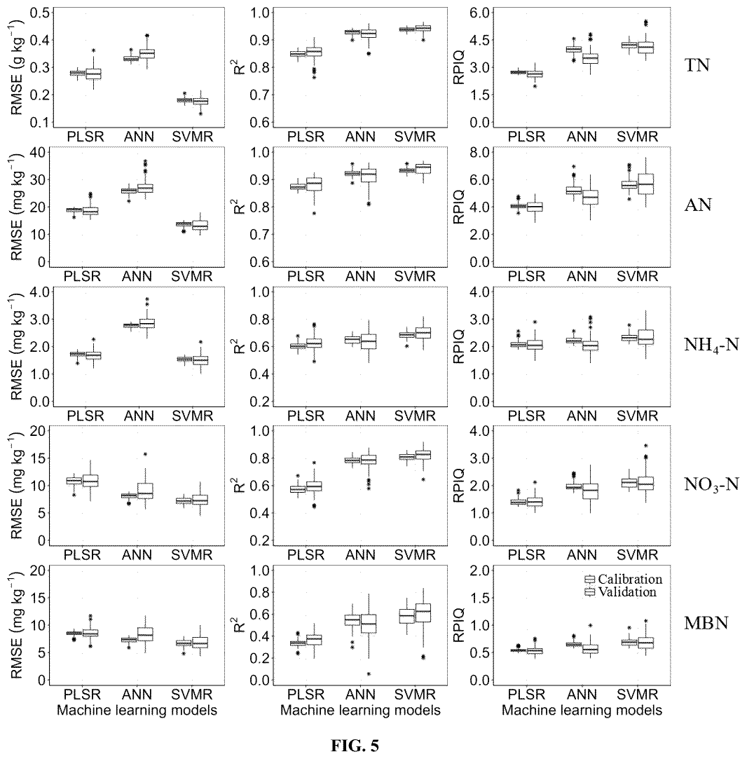

FIG. 5 shows a performance index box diagram of different machine learning models established by randomly dividing the modeling set-validation set for 100 times. It can be seen from the figure that the prediction model of five types of soil nitrogen established by SVMR had the maximum R² and RPIQ values, and a minimum RMSE value, indicating that the SVMR model had high prediction accuracy and strong robustness.

In a further embodiment, outputting the visualized image was implemented in R 3.5 open source software and ArcGIS 9.3, with the process as follows:

obtaining a soil hyperspectral image based on a soil profile sample, obtaining each pixel on the soil hyperspectral image and a corresponding spectral reflectance curve, inputting the spectral reflectance curve into the optimal prediction model, and obtaining a predicted gray-scale image by means of the optimal prediction model, where the predicted gray-scale image includes at least a plurality of predicted pixels and spatial positions corresponding to the predicted pixels; and

performing pseudo-color processing on the predicted gray-scale image by using ArcGIS 9.3 to obtain a visualized image about contents of total nitrogen, alkali-hydrolyzable nitrogen, ammonium nitrogen, nitrate nitrogen and microbial biomass nitrogen in the soil profile sample,

where the visualized image is a color distribution map.

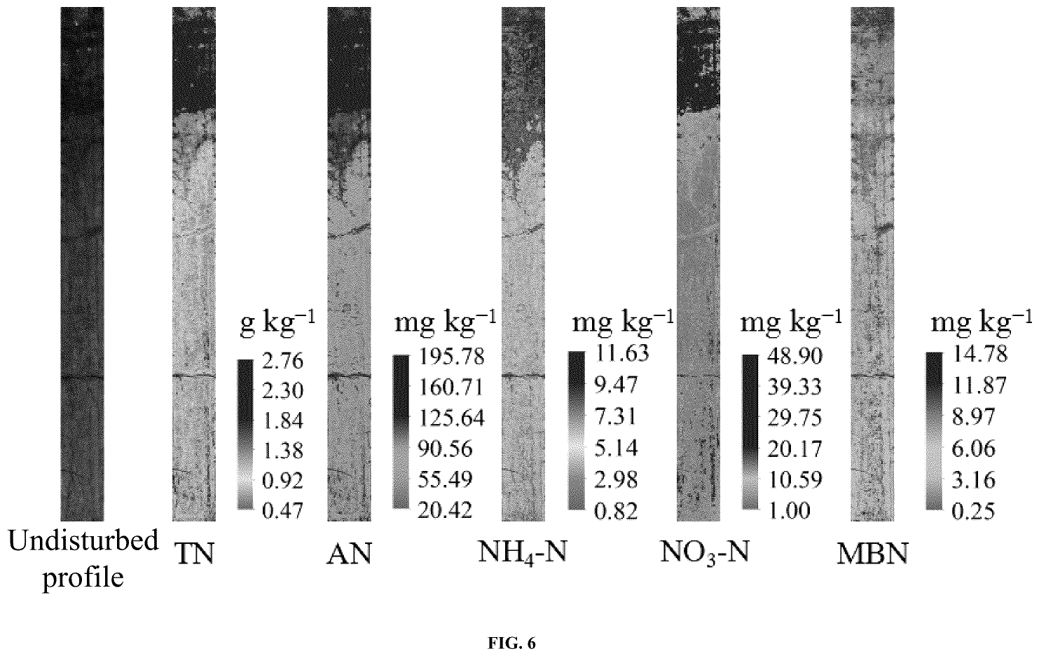

In FIG. 6, blue represents a high content and red represents a low content. The predicted distribution map can well show the general trend of different forms of nitrogen contents in the entire soil profile, that is, with the deepening of a soil layer, the contents of different forms of soil nitrogen shows a sharp decline layer by layer, with the highest total nitrogen content in top soil and the lowest total nitrogen content in bottom soil. The predicted distribution map can further reflect spatial distribution information of the content of soil nitrogen in millimeter level in the profile, and can show differences in contents of various forms of nitrogen in the same soil profile or different soil profiles in a more detailed and visual way. According to the present disclosure, a feasible technical means can be provided for prediction and visualized mapping of contents of different forms of nitrogen in a farmland soil profile.

1. A machine learning-based hyperspectral detection and visualization method of a nitrogen content in a soil profile, comprising at least the following steps:
sampling soil in a detection area based on a predetermined depth to obtain a plurality of soil profile samples about the detection area; obtaining an initial hyperspectral image of each soil profile sample, and performing image preprocessing on the initial hyperspectral image to obtain an effective hyperspectral image;
selecting n regions of interest that are continuously distributed and have the same shape and size on the effective hyperspectral image, and calculating n pieces of average spectral data based on all pixels of each region of interest, wherein n is an integer; detecting contents of at least five forms of nitrogen in the soil profile samples in each region of interest to obtain a standard content of each form of soil nitrogen; and
establishing a plurality of hyperspectral prediction models by using at least one learning algorithm; selecting an optimal prediction model corresponding to a soil nitrogen form from the plurality of hyperspectral prediction models based on evaluation indexes, predicting a soil nitrogen content corresponding to each pixel of the hyperspectral image of the soil profile in the corresponding form based on the optimal prediction model, denoting the soil nitrogen content as a predicted soil nitrogen content, and outputting the predicted soil nitrogen content to obtain a visualized image.

2. The machine learning-based hyperspectral detection and visualization method of a nitrogen content in a soil profile according to claim 1, wherein a process of establishing the hyperspectral prediction model comprises the following steps:
detecting outliers of all the average spectral data by using a principal component analysis method to determine whether there is an abnormal average spectral curve, and if yes, eliminating the abnormal average spectral curve; and randomly dividing filtered average spectral data into a modeling set and a validation set at 7:3;
assigning a value range and a search step size to parameters of each learning algorithm to obtain a corresponding parameter combination; for each form of soil nitrogen, performing parameter optimization on each parameter combination by grid search and 10-fold cross-validation to obtain a corresponding optimal parameter combination; and
establishing a regression relationship between hyperspectral signals and different soil nitrogen contents based on the optimal parameter combination with preprocessed average spectral data as a predictive variable and the standard content of soil nitrogen as a response variable.

3. The machine learning-based hyperspectral detection and visualization method of a nitrogen content in a soil profile according to claim 1, wherein the learning algorithm comprises at least a partial least square regression (PLSR) algorithm, an artificial neuron network (ANN) algorithm, and a support vector machine regression (SVMR) algorithm; and
correspondingly, the plurality of hyperspectral prediction models are a PLSR prediction model, an ANN prediction model, and an SVMR prediction model.

4. The machine learning-based hyperspectral detection and visualization method of a nitrogen content in a soil profile according to claim 1, wherein the evaluation index comprises at least a determination coefficient, a root mean square error, and a quartile relative prediction error; and a process of selecting the optimal prediction model comprises the following step:
evaluating evaluation values of five forms of soil nitrogen predicted by different hyperspectral prediction models in the modeling set and the validation set, and selecting according to the following criteria:
$$\{ \begin{matrix}{R}^{2} \geq 0.9 and RPIQ \geq 4.05 & Excellent fitting performance \\ 0.82 \leq {R}^{2} < 0.9 and 3.37 \leq RPIQ < 4.05 & Good fitting performance \\ 0.66 \leq {R}^{2} < 0.82 and 2.7 \leq RPIQ < 3.37 & Fitting approximately quantitatively \\ 0.5 \leq {R}^{2} < 0.66 and 2.02 \leq RPIQ < 2.7 & Only a high value and a low \\ & value is distinguished \\ {R}^{2} < 0.5 and RPIQ < 2.02 & It is difficult to be used for \\ & quantitative analysis\end{matrix}$$
wherein R² represents an evaluation value of the determination coefficient, and RPIQ represents an evaluation value of the quartile relative prediction error.

5. The machine learning-based hyperspectral detection and visualization method of a nitrogen content in a soil profile according to claim 1, wherein a process of outputting the visualized image comprises the following steps:
obtaining a soil hyperspectral image based on a soil profile sample, obtaining each pixel on the soil hyperspectral image and a corresponding spectral reflectance curve, inputting the spectral reflectance curve into the optimal prediction model, and obtaining a predicted gray-scale image by means of the optimal prediction model, wherein the predicted gray-scale image comprises at least a plurality of predicted pixels and spatial positions corresponding to the predicted pixels; and
performing pseudo-color processing on the predicted gray-scale image to obtain a visualized image about contents of total nitrogen, alkali-hydrolyzable nitrogen, ammonium nitrogen, nitrate nitrogen and microbial biomass nitrogen in the soil profile sample, wherein the visualized image is a color distribution map.

6. The machine learning-based hyperspectral detection and visualization method of a nitrogen content in a soil profile according to claim 1, wherein the five forms of nitrogen is soil total nitrogen, alkali-hydrolyzable nitrogen, ammonium nitrogen, nitrate nitrogen, and microbial biomass nitrogen.

7. The machine learning-based hyperspectral detection and visualization method of a nitrogen content in a soil profile according to claim 3, wherein
an optimal parameter combination of the PLSR prediction model is a corresponding parameter combination when a root mean square error value of 10-fold cross-validation is minimum or has no significant change; and
optimal parameter combinations of the ANN prediction model and the SVMR prediction model each are a parameter combination corresponding to a minimum root mean square error value of 10-fold cross-validation.

8. The machine learning-based hyperspectral detection and visualization method of a nitrogen content in a soil profile according to claim 1, wherein the image preprocessing of the initial hyperspectral image comprises at least the following process:
performing gray-scale and geometric correction on the initial hyperspectral image, and sequentially denoising and stretching.

9. The machine learning-based hyperspectral detection and visualization method of a nitrogen content in a soil profile according to claim 1, wherein a method for preprocessing the average spectral data comprises one or more of an apparent absorption rate, a first derivative, a second derivative, Savitzky-Golay smoothing, a Gap-Segment derivative, detrending, or standard normal variable transformation.

10. The machine learning-based hyperspectral detection and visualization method of a nitrogen content in a soil profile according to claim 2, wherein the learning algorithm comprises at least a partial least square regression (PLSR) algorithm, an artificial neuron network (ANN) algorithm, and a support vector machine regression (SVMR) algorithm; and
correspondingly, the plurality of hyperspectral prediction models are a PLSR prediction model, an ANN prediction model, and an SVMR prediction model.

11. The machine learning-based hyperspectral detection and visualization method of a nitrogen content in a soil profile according to claim 5 wherein the five forms of nitrogen is soil total nitrogen, alkali-hydrolyzable nitrogen, ammonium nitrogen, nitrate nitrogen, and microbial biomass nitrogen.

12. The machine learning-based hyperspectral detection and visualization method of a nitrogen content in a soil profile according to claim 10, wherein
an optimal parameter combination of the PLSR prediction model is a corresponding parameter combination when a root mean square error value of 10-fold cross-validation is minimum or has no significant change; and
optimal parameter combinations of the ANN prediction model and the SVMR prediction model each are a parameter combination corresponding to a minimum root mean square error value of 10-fold cross-validation.
